(19) United States
(12) Patent Application Publication
(10) Pub. No.: US 2014/0363275 A1
(43) Pub. Date: Dec. 11, 2014

(54) FORCE GENERATING DEVICE

(71) Applicant: Liuzhou-Shi Zhongjingkeji Co., Ltd., Liuzhou (CN)

(72) Inventor: Xin LI, Liuzhou (CN)

(21) Appl. No.: 14/469,556

(22) Filed: Aug. 26, 2014

Related U.S. Application Data
(63) Continuation-in-part of application No. PCT/CN2013/072032, filed on Feb. 28, 2013.

(30) Foreign Application Priority Data
Feb. 28, 2012 (JP) 2012-041531

(51) Int. Cl. F04D 17/10; B23Q 3/00; B25J 15/06; F04D 29/42; F04D 27/00

(52) U.S. Cl. CPC F04D 17/10; F04D 29/4213; F04D 27/001; B25J 15/0616; B23Q 3/00
USPC 415/118

(57) ABSTRACT

A force generating device, including: a cup member, fan blades, and a calculus member for calculating the pressure. The cup member includes a recess and a suction inlet. The suction inlet is disposed at the bottom surface of the cup member. The fan blades are disposed inside the recess of the cup member. Air is sucked into the recess from the suction inlet and produces a swirl therein by rotation of the fan blades. The calculus member calculates the pressure according to the equation: Pi(r)=½·ρ·r²·ω²+C, in which, r represents the distance between a point inside the chamber of the recess of the cup member and the revolving center of the fan blades, Pi(r) represents a pressure at the point, ρ represents the density of the air, ω represents an angular velocity of the swirl, and C represents a coefficient.

### CROSS-REFERENCE TO RELATED APPLICATIONS

This application is a continuation-in-part of International Patent Application No. PCT/CN2013/072032 with an international filing date of Feb. 28, 2013, designating the United States, now pending, and further claims priority benefits to Japanese Patent Application No. 2012-041531 filed Feb. 28, 2012. The contents of all of the aforementioned applications, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, Mass. 02142.

### BACKGROUND OF THE INVENTION

1. Field of the Invention

The invention relates to a force generating device that is able to exert force on an object without contacting with the object.

2. Description of the Related Art

Conventional gripping tools or devices used to grip workpieces tend to touch the workpieces, which causes scratches and static electricity thereby producing discarded products and defective products.

In recent years, non-contact gripping tools or devices have been developed and applied in the production. A typical non-contact transporting/gripping device includes a housing and an internal member. The internal member is provided with a supplying port and is mounted inside the housing. The housing and the internal member are connected via a connecting bolt. The air is transported to the supplying port and then introduced to an annular channel via a connecting channel. By enabling the air to flow in an annular groove, the workpiece is maintained at a non-contact state relative to a supporting surface of the internal member. A cross section of the annular groove is designed to be substantially trapezoidal.

The non-contact transporting/gripping device utilizes the air swirl produced in a cylinder to produce a negative pressure in a central part of the cylinder, through which, the object is sucked and suspended.

Such non-contact transporting/gripping devices are generally called force generating devices. In practical application, it is desired to know the magnitude of the attraction force or the repulsion force exerted on the object by the force generating device. However, the conventional means, for example, a force sensor, is incapable of directly measuring the magnitude of the force exerted on the object.

### SUMMARY OF THE INVENTION

In view of the above-described problems, it is one objective of the invention to provide a force generating device that is able to calculate the pressure distribution or the magnitude of the force.

To achieve the above objective, in accordance with one embodiment of the invention, there is provided a force generating device, comprising: a cup member, the cup member comprising a recess and a suction inlet; fan blades; and a calculus member configured to calculate a pressure. The recess is disposed at a bottom of the cup member and a cross section of the recess is slightly rounded. The suction inlet is disposed at a bottom surface of the cup member. The recess comprises a chamber communicating with the suction inlet. The fan blades are disposed inside the recess of the cup member. Air is sucked into the recess from the suction inlet and produces a swirl by rotation of the fan blades. The calculus member calculates the pressure according to equation: Pi(r)=½·ρ·²·ω²+C, in which, r represents a distance between a point inside the chamber of the recess of the cup member and a revolving center of the fan blades, Pi(r) represents a pressure at the point, ρ represents a density of the air, ω represents an angular velocity of the swirl, and C represents a coefficient.

In a class of this embodiment, the device further comprises: at least one pressure sensor for measuring the pressure at one point, and a rotational speed sensor for measuring the angular velocity of the swirl in the recess. Based on a measured pressure and angular velocity, the calculus member calculates the value of coefficient C.

In a class of this embodiment, a detection position of the pressure sensor is disposed at a rotational shaft of the fan blades, and a pressure detected by the pressure sensor is Pi(0).

In a class of this embodiment, the device comprises at least two pressure sensors for measuring pressures in the recess at two points having different distance; and the calculus member calculates the coefficient C and a square of a rotational speed (ω²) according to measured pressures of at least the two points.

In a class of this embodiment, a detection position of the pressure sensor is disposed at a rotational shaft of the fan blades, and a pressure detected by the pressure sensor is Pi(0).

In a class of this embodiment, an inner side surface of the cup member is a cylindrical surface, and a diameter of the cylindrical surface is R₁. An outer side surface of the cup member is a cylindrical surface, and a diameter of the cylindrical surface is R₂. The pressure calculated by the calculus member further comprise Po(r)=Pi(R₁)/ln(R₁/R₂)·ln(r/R₂).

Advantages according to embodiments of the invention are summarized as follows: The cup member is provided with the calculus member that calculates the pressure based on the corresponding equations, thereby being convenient for the user to know the parameter of the pressure.

### BRIEF DESCRIPTION OF THE DRAWINGS

The invention is described hereinbelow with reference to the accompanying drawings, in which:

FIG. 1 is a structure diagram of a non-contact gripping tool in accordance with Example 1 of the invention;

FIG. 2 is a cross sectional view taken from line A-A of FIG. 1;

FIG. 3 is a top view of a non-contact gripping tool in accordance with Example 1 of the invention;

FIG. 4 is a structure diagram of fan blades in accordance with Example 2 of the invention;

FIG. 5 is a structure diagram of fan blades in accordance with Example 3 of the invention;

FIG. 6 is a pressure distribution diagram in accordance with Example 1 of the invention;

FIG. 7 is a chart showing relationship between a distance from an air outlet to a sucked workpiece and a suction force in accordance with Example 1 of the invention;

FIG. 8 is a non-contact gripping tool in accordance with Example 4 of the invention;

FIG. 9 is a cup member of a non-contact gripping tool in accordance with Example 1 of the invention;

FIG. 10 is a cup member of a non-contact gripping tool in accordance with Example 5 of the invention;

FIG. 11 is a cup member of a non-contact gripping tool in accordance with Example 6 of the invention;

FIG. 12 is a structure diagram of a non-contact gripping tool and a pressure distribution diagram therein;

FIG. 13 is a force generating device in accordance with Example 1 of the invention;

FIG. 14 is a chart showing calculation results and measurement results of pressure distribution in accordance with Example 1; and

FIG. 15 is a force generating device in accordance with Example 7.

### DETAILED DESCRIPTION OF THE EMBODIMENTS

For further illustrating the invention, experiments detailing a force generating device are described below. It should be noted that the following examples are intended to describe and not to limit the invention.

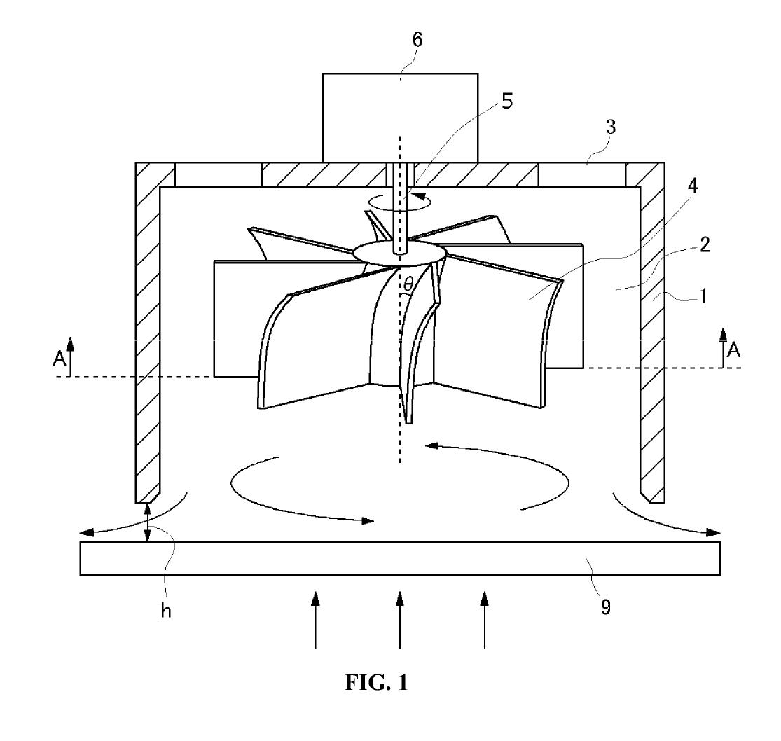

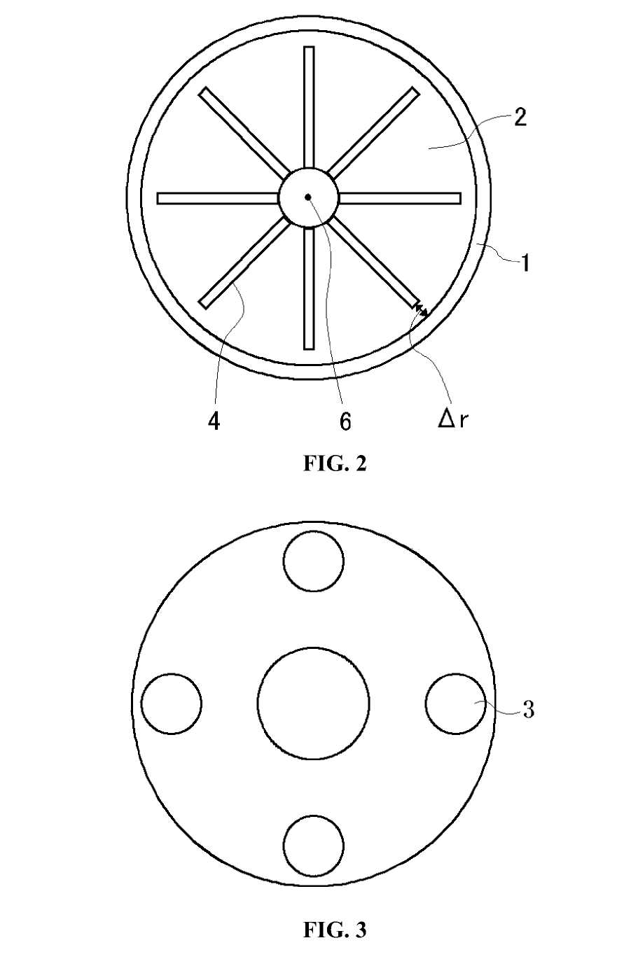

A force generating device described in Example 1 is shown in FIGS. 1-3, 9, and 13. The force generating device comprises a cup member 1. A bottom of the cup member is provided with a recess 2 having a slightly rounded cross section. A suction inlet 3 is disposed at a bottom surface of the cup member. The suction inlet communicates with a chamber of the recess. Fan blades 4 are disposed inside the recess 2 of the cup member 1. Air is sucked into the recess from the suction inlet 3 and produces a swirl by rotation of the fan blades. Each of the fan blades has an arc shaped cross section. The fan blades 4 are connected to a motor 6 disposed on a top of the cup member 1 via a rotational shaft 5. An included angle between the rotational shaft 5 and each fan blade 4 is between 0.5 and 20°. As the fan blades 4 are in curved shapes, the air is sucked in via the suction inlet 3.

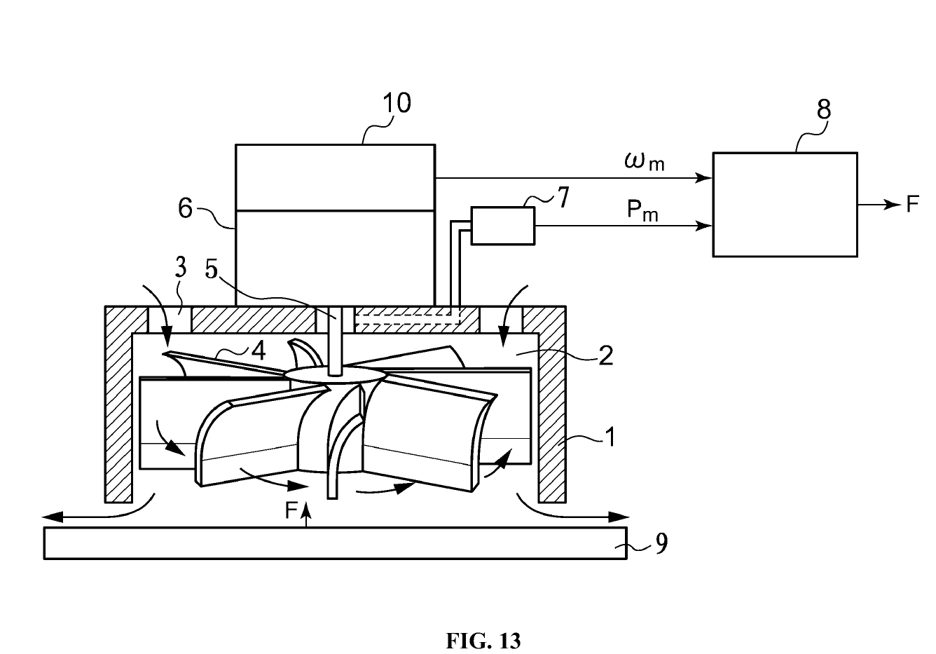

Eight fan blades 4 are provided in this example. The rotation of the motor 6 drives the fan blades 4 to rotate in a direction indicated by arrows in FIGS. 1 and 13. An inner side of an air outlet of the cup member 1 is processed into an inclined surface in order to decrease flow resistance of the air discharged from an upper part of the cup member. A pressure sensor 7 is disposed on the top of the cup member 1, and an output end of the pressure sensor is connected to a calculus member 8. The calculus member 8 is configured to calculate a pressure according to the equation: Pi(r)=½·ρ·r²·ω²+C, in which, r represents a distance between a point inside the chamber of the recess of the cup member and a revolving center of the fan blades, Pi(r) represents a pressure at the point, ρ represents a density of the air, ω represents an angular velocity of the swirl, and C represents a coefficient.

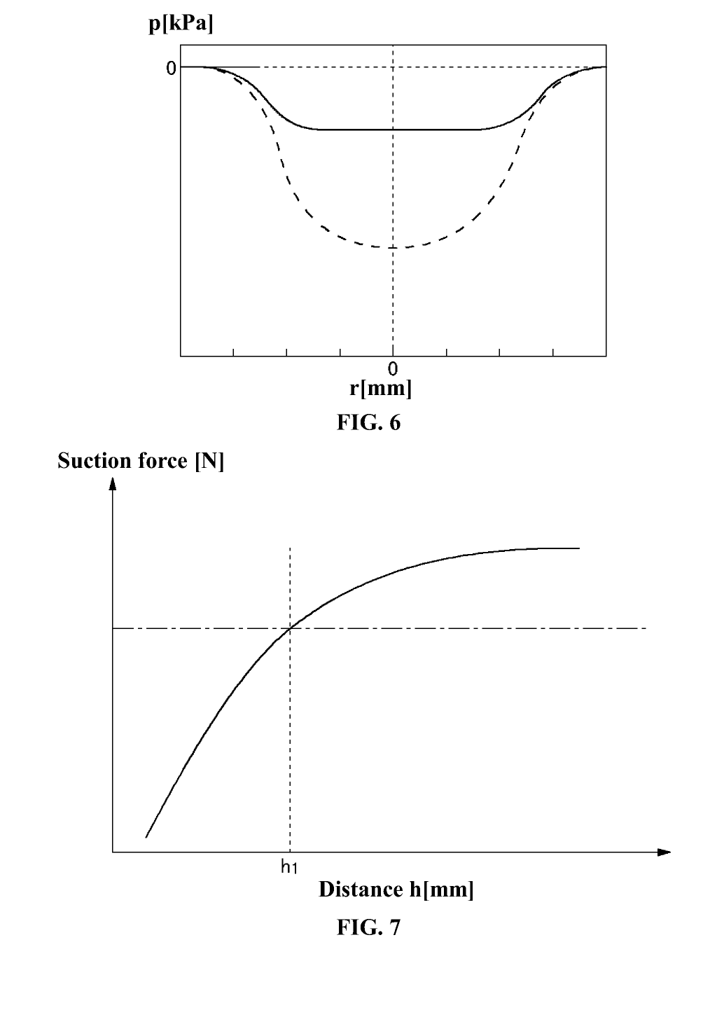

A workpiece 9 is disposed at a bottom of the cup member 1. At such a state, the motor 6 begins to rotate at a rotational speed of between 1000 and 20000 rpm, so that the swirl is produced in the recess 2 of the cup member 1. Distribution of negative pressure produced by the swirl in the cup member 1 is shown in FIG. 6, in which, a lateral axis indicates a distance r in a radius direction, a longitudinal axis indicates a pressure. The swirl produced in the recess 2 of the cup member 1 enables the air to move towards a periphery of the cup member under the action of the centrifugal force, thereby decreasing the air density of a central part and decreasing the pressure to the atmospheric pressure below. When the workpiece 9 is then disposed beneath the cup member 1, the negative pressure is acted on an upper surface of the workpiece 9, and the negative pressure is distributed along the radius direction, as shown in FIG. 6. As pressure difference exists between the upper surface and the lower surface of the workpiece, a suction force is produced, so that the workpiece 9 is gripped by the non-contact gripping tool.

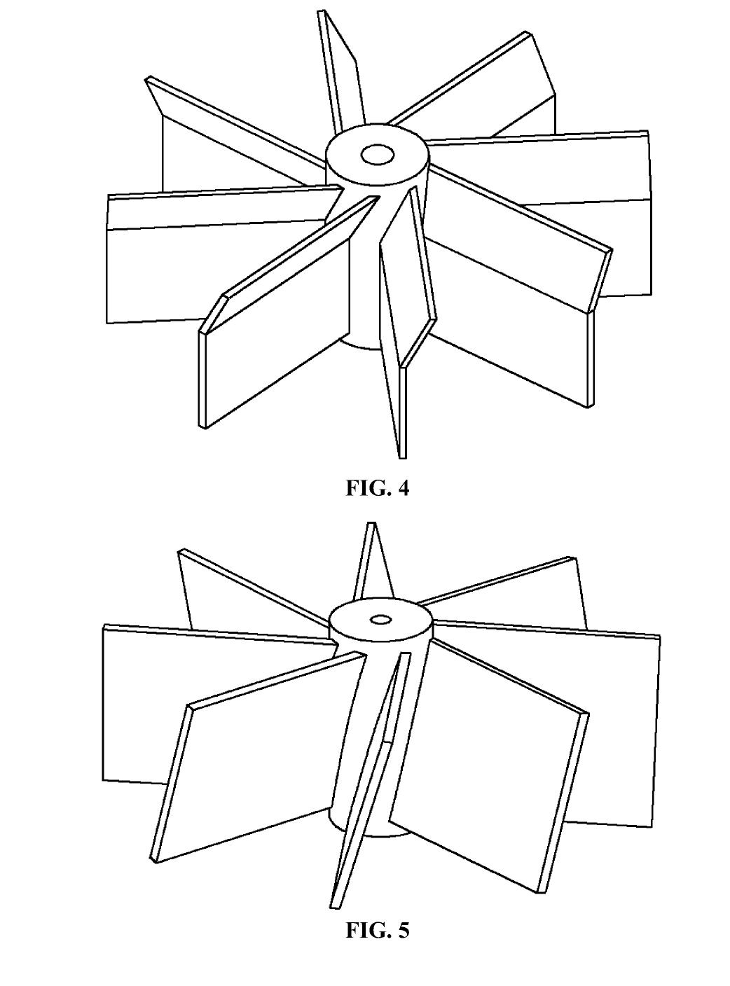

FIG. 4 shows the fan blades of Example 2, where the fan blades are bent at a position of a certain height.

FIG. 5 shows fan blades of Example 3, where the fan blades are inclinedly disposed in a rotational direction of the rotational shaft.

FIG. 7 is a curve chart showing the relation between a distance h from the bottom part of the cup member to the workpiece and a suction force. The curve chart indicates that the suction force increases along with the increase of the distance h within a certain range. A dot-and-dash line indicates a gravity of the workpiece and intersects with the curve line indicating the suction force at one point, which means that the gravity is equivalent to the suction force at this point. In a stable state, the workpiece is suspended at this position.

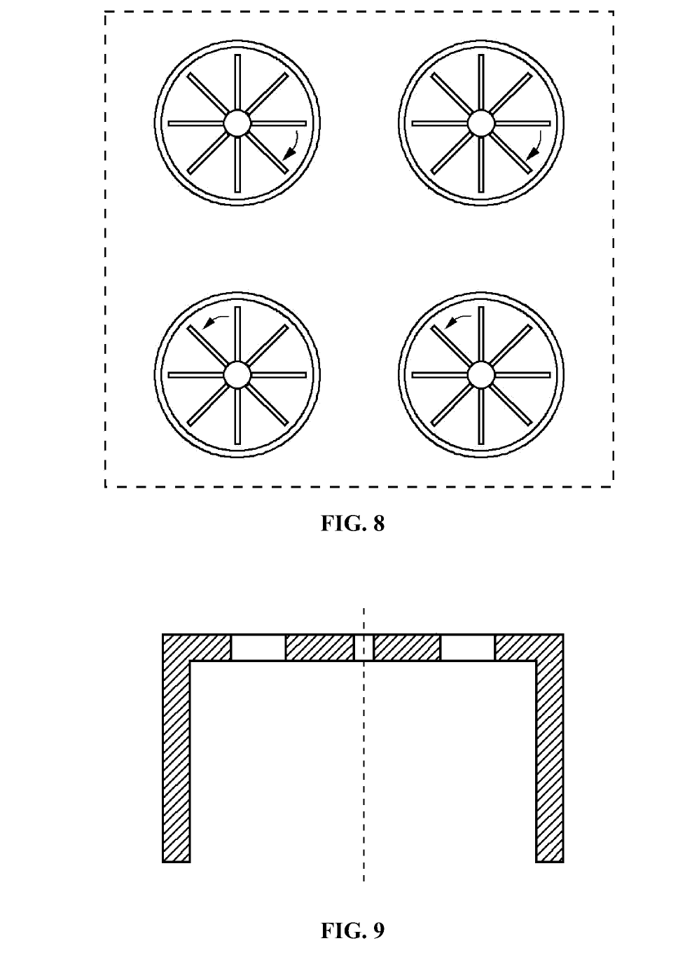

In conditions that only one non-contact gripping tool shown in FIG. 1 is employed, the swirl possibly drives the workpiece to rotate. In order to prevent the workpiece from rotating, a plurality of non-contact gripping tools is generally used to grip one workpiece. A plurality of the non-contact gripping tools is employed in Example 4, as shown in FIG. 8. The non-contact gripping device comprises four non-contact gripping tools. A dashed line in FIG. 8 indicates the workpiece 9. In order to counteract rotary torques acting on the workpiece, directions of the swirls formed by the four non-contact gripping tools are designed to be different. In FIG. 8, two non-contact gripping tools in the upper part produce swirls in clockwise direction, and two non-contact gripping tools in the upper part produce swirls in the counter-clockwise direction. Or, the directions of the swirls produced by the two groups of the non-contact gripping tools are exchanged.

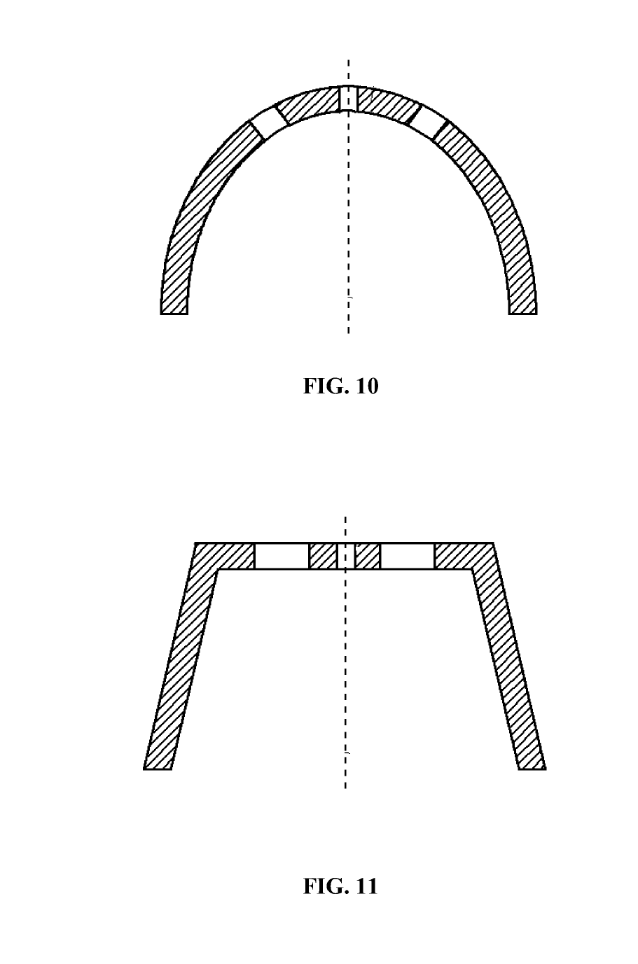

FIG. 9 is a cross sectional view of the cup member in a direction of the rotational shaft in Example 1, the cross section is in a rectangular shape. FIG. 10 is a cross sectional view of the cup member in the direction of the rotational shaft in Example 5, the cross section is in a semicircular shape. FIG. 11 is a cross sectional view of the cup member in the direction of the rotational shaft in Example 6, the cross section is in a trapezoidal shape. The shape of the fan blades 4 of a turbofan is designed according to the shape of the recess of the cup member, and the fan blades do not contact with the recess.

As shown in FIG. 8, when a plurality of non-contact gripping tools are utilized to grip one workpiece, forces on the workpiece exerted by the non-contact gripping tools are different from each other in practical transportation process, thereby easily resulting in inclination of the workpiece or even contact between the workpiece and the non-contact gripping tools. In order to safely and completely reach the non-contact grip and transportation of the workpiece, it is necessary to know the force produced by each non-contact gripping tool.

Furthermore, in practical transportation process when workpieces of different weights are to be gripped and transported, it is required to regulate the forces of the non-contact gripping tools according to the weight of workpiece, so that the weight of the workpiece must be measured on the premise of non-contacting with the workpiece.

When using the non-contact gripping tools to transport the workpiece, the non-contact gripping tools move up and down in the vertical direction in gripping the workpiece. In condition of too large an acceleration of the non-contact gripping tools in the vertical direction, the workpiece is unable to follow the movement of the non-contact gripping tool, thereby falling down. To solve the problem, it is required to properly regulate the force according to the acceleration of the non-contact gripping tool in the vertical direction. Thus, it is necessary to infer the pressure distribution or the force of the non-contact gripping tool.

In practical applications, it is required to know the force produced by the non-contact gripping tool. However, the conventional mechanical method is unable to measure the force of the non-contact gripping tools in the absence of contact between the non-contact gripping tools and the workpiece.

Thus, the pressure distribution and the force of the non-contact gripping tools are inferred as follows:

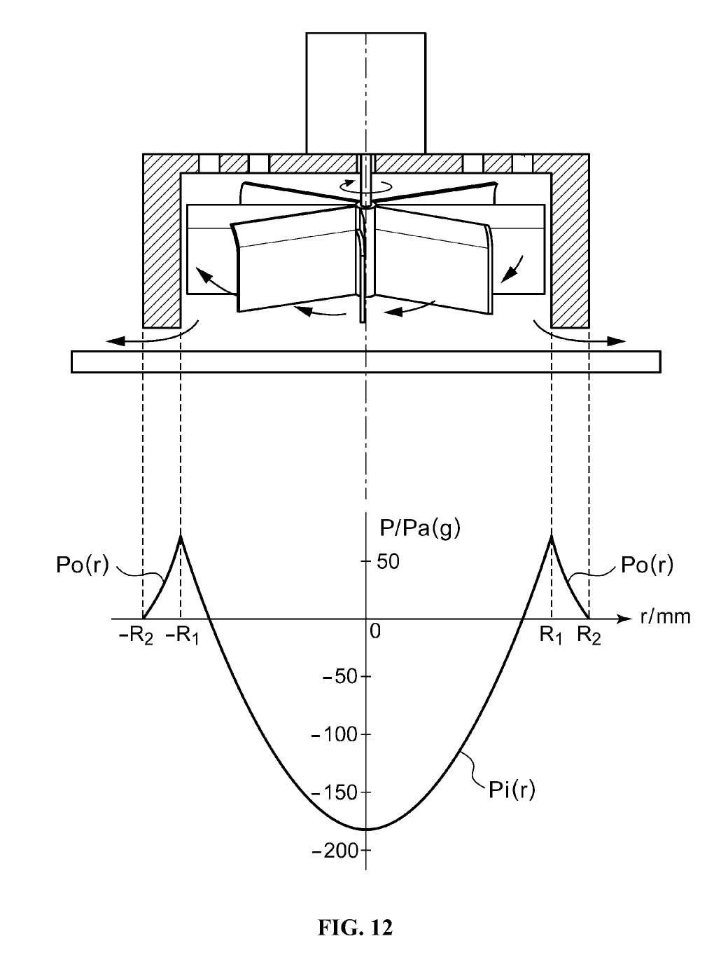

The non-contact gripping tool and the pressure distribution thereof are shown in FIG. 12. r represents a radius of a random point, R₁ is an inner radius of the cup member, and R₂ is an outer radius of the cup member. An air swirl having an angle velocity of ω is produced in the recess 2 by using the fan blades 4. Thus, the pressure Pi(r) of the swirl at a constant rotational speed is distributed within the range of radius r<R₁. The flowing inertia force, that is, the centrifugal force of the swirl, plays a supporting role, and can be represented by the following equation:

ρ·r·ω²=dPi(r)/dr

Integration of the differential equation is performed in the radius direction to obtain equation (1), in which, a unit of the pressure Pi(r) is a gauge pressure:

Pi(r)=½·ρ·r²·ω²+C (1)

ρ represents the density of the gas (the air), ω represents the angle velocity of the swirl in the cup member, C represents a coefficient. In another words, the pressure Pi(r) distribution is in a parabolic shape. Besides, in order to specifically calculate the pressure Pi(r) using the equation (1), a distance between an outermost end of each fan blade 4 and an inner wall of the cup member 1 must be as small as possible.

The non-contact gripping tool in the working sate is capable of producing the swirl having a certain rotational speed. Thus, the pressure Pi(r) within the range of r <R₁ can be approximately expressed by the equation (1).

Furthermore, within the range of R₁<r<R₂, the viscosity of the air plays a primary dominant role. The pressure Po(r) distribution can be expressed by the following differential equation:

d(r·dPo(r)/dr)/dr=0

Integration of the differential equation is performed in the radius direction to obtain:

Po(r)=Pi(R₁)/ln(R₁/R₂)·ln(r/R₂) (2)

Herein the pressure Po(r) is a gauge pressure, that is, the pressure Po(r) distribution of the non-contact gripping tool at the working state within the range of R₁<r<R₂ can be approximately expressed by the equation (2).

As shown in FIG. 13, the calculus member 8 calculates the pressure Pi(r) distribution and the pressure Po(r) distribution based on the equation (1) and the equation (2), respectively. The equation (1) and the equation (2) comprise unknown parameters, such as the integral coefficient C, the angle velocity ω, and Pi(R₁), which change along with the change of the distance between the non-contact gripping tool and the workpiece 9. Thus, it is necessary for the non-contact gripping tool to calculate the unknown parameters C, ω, and Pi(R₁). Such parameters are acquired in real time by the pressure sensor 7 and the rotational speed sensor 10.

The pressure sensor 7 measures pressures of at least one point within the range of r<R₁ with a certain sampling period. The pressure sensor 7 is disposed above the cup member 1. Pressures at points of the same radius within the cup member 1 in the vertical direction are equivalent. This has been demonstrated by experiments. Thus, the pressure detected by the pressure sensor disposed above the cup member is equal to the pressure at points of the same radius on the workpiece 9.

The rotational speed sensor 10 measures the rotational speed of the fan blades, i. e., the rotational speed of the swirl, with a certain sampling period. For example, the rotational speed sensor 10 utilizes an external grating encoder, or a Hall sensor disposed inside the motor; or the rotational speed is calculated by detecting the current and the voltage of the motor.

The equation (1) is derived into equation (3):

C=Pi(r)−½·ρ·r²·ω² (3)

A measured pressure value Pₘ at points of a radius of rₘ and the measured rotational speed value ωₘ are put into the equation (3) to calculate the coefficient C.

C=Pₘ−½·ρ·rₘ²·ωₘ² (4)

In the non-contact gripping tool shown in FIG. 13, the pressure sensor 7 is arranged at a point of rₘ=0 to measure the pressure Pi(0). The pressure Pi(r) distribution slightly varies at the point of radius r=0. Thus, the precision of the mounting position of the pressure sensor is not highly required. In another word, even slight deviations occur in the position for mounting the pressure sensor, the results of the pressure distribution calculated by the equation (1) will not be seriously affected.

In such conditions, the equation (4) can be simplified as equation (4′), and the measured pressure value Pₘ is equal to the coefficient C.

C=Pₘ (4′)

In another word, the non-contact gripping tool is capable of using the equation (1′) to calculate Pi(r).

Pi(r)=½·ρ·r²·²·ωₘ²+Pₘ (1′)

When the coefficient C is calculated, the pressure distribution Pi(r) within the range of the radius r<R₁ is known. The Pi(r) can be used to calculate the pressure Pi(R₁) at the points of the radius r=R₁. When the Pi(R₁) is acquired, the pressure distribution Po(r) within the range of R₁ <r <R₂ can be calculated according to the equation (2).

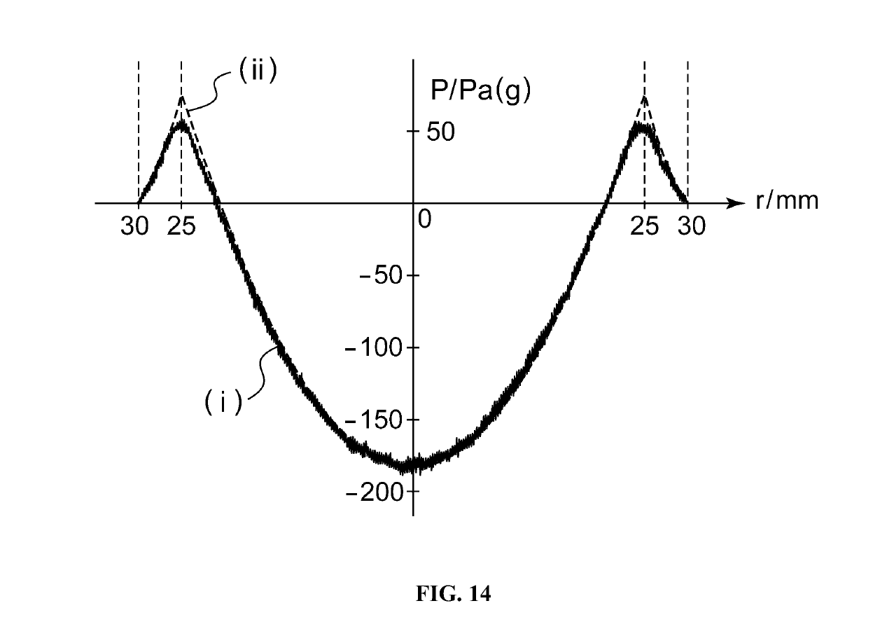

FIG. 14 illustrates the comparison between the calculated pressure distribution based on the equation (1) and the measured results of the pressure distribution obtained from the experiments. A solid line (i) indicates the measured value, and a dash line (ii) indicates the calculated value. The calculated value is consistent with the measured value except the errors occurring around the point of r=R₁.

The force produced by the non-contact gripping tool can be calculated by area integration of the equation (1) and the equation (2), and the formula is as follows:

F=∫₀^{R1}[2πr·Pi(r)]dr+∫_{R1}^{R2}[2πr·Po(r)]dr (5)

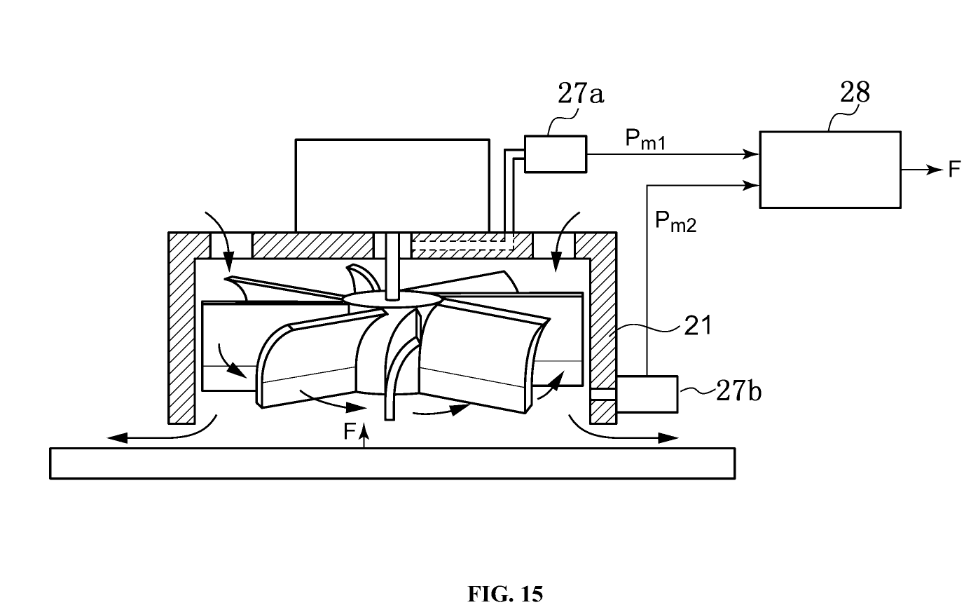

As shown in FIG. 15 in Example 7, the cup member 21 is provided with the calculus member 28 and two pressure sensors 27a and 27b.

The pressure sensors 27a and 27b are mounted in the range of r<R₁, and the points thereof have different distance from the center. At least two points of rₘ₁ and rₘ₂ must be provided with pressure sensors to measure the pressures Pₘ₁ and Pₘ₂.

The pressure values Pₘ₁ and Pₘ₂ of at least two points are utilized by the calculus member 28 to calculate the coefficient C and a second power of the angle velocity ω². Pressure values Pₘ₁ and Pₘ₂ at these two points are used to calculate the coefficient C and ω² by using the following two equations.

Pₘ₁=½·ρ·rₘ₁²·ω²+C (1a)

Pₘ₂=½·ρ·rₘ₂²·ω²+C (1b)

In the non-contact gripping tool of Example 7, the pressure sensor 27a is arranged at the point of rₘ=0 to measure the pressure Pₘ₁. The pressure Pi(r) distribution slightly varies at the point of radius r=0. Thus, the precision of the mounting position of the pressure sensor is not highly required. In another word, even slight deviations occur in the position for mounting the pressure sensor, the result of the pressure distribution calculated by the equation (1) will not be seriously affected. The measured value of the pressure Pₘ₁ is equal to the coefficient C, thereby simplifying the calculation.

ω² is calculated by the equation (6):

ω²=2·(Pₘ₁−Pₘ₂)/rₘ₂² (6)

The pressure sensor 27b is mounted at the point of rₘ₂=R₂ to measure the pressure Pₘ₂.

When the calculus member 28 calculates the ω² and C, and the pressure distribution of Pi(r) and Po(r) are calculated based on the equation (1) and the equation (2). Area integration of the pressure distribution Pi(r) and Po(r) are performed by the calculus member 28, and the magnitude of the force exerted on the workpiece by the non-contact gripping tool is acquired.

Based on the above description, it is known that the pressure distribution P(r) and the force F can be calculated based on the non-contact gripping tool.

When the workpiece is stationary or moving with uniform linear motion, the force F inferred by the calculus member is equal to the weight of the non-contact gripping tool. That is, the non-contact gripping tool in the working state is capable of measuring the weight of the workpiece. When the weight of the workpiece is acquired, the inertia force causing the acceleration or deceleration in the vertical direction is known, so that the rotational speed of the motor can be properly controlled, and the force F acted on the workpiece can be properly controlled.

Because the force F is calculated, a negative feedback control system of the force can be established by using the calculated value of the force. In another word, a difference between the calculated value and the objective value of the force F is utilized to control the rotational speed of the motor. By controlling the motor, it is proper to control the force F acted on the workpiece. For example, when the non-contact gripping tool moves upwards in the vertical direction, the control of the force F is conducted according to the acceleration of the movement, thereby preventing the workpiece from falling down or contact between the non-contact gripping tool and the workpiece.

The non-contact gripping tool is also capable of producing a compulsion force which is produced when the integration value of the pressure distribution is positive.

Thus, the non-contact gripping tool is capable of accurately control the force exerted on the object, and is a force generating device that exerts the force on the workpiece in the form of non-contact. Besides, the non-contact gripping tool can be used as a non-contact gravimeter or a non-contact force measuring device.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A force generating device, comprising:
a) a cup member, the cup member comprising a recess and a suction inlet;
b) fan blades; and
c) a calculus member, the calculus member being configured to calculate a pressure;
wherein
the recess is disposed at a bottom of the cup member and a cross section of the recess is slightly rounded;
the suction inlet is disposed at a bottom surface of the cup member;
the recess comprises a chamber communicating with the suction inlet;
the fan blades are disposed inside the recess of the cup member;
air is sucked into the recess from the suction inlet and produces a swirl by rotation of the fan blades; and
the calculus member calculates the pressure according to an equation: Pi(r)=½·ρ·r²·ω²+C, in which, r represents a distance between a point inside the chamber of the recess of the cup member and a revolving center of the fan blades, Pi(r) represents a pressure at the point, ρ represents a density of the air, ω represents an angular velocity of the swirl, and C represents a coefficient.

2. The device of claim 1, wherein
the device further comprises: at least one pressure sensor for measuring the pressure at one point, and a rotational speed sensor for measuring the angular velocity of the swirl in the recess; and
based on a measured pressure and angular velocity, the calculus member calculates the value of coefficient C.

3. The device of claim 2, wherein a detection position of the pressure sensor is disposed at a rotational shaft of the fan blades, and a pressure detected by the pressure sensor is Pi(0).

4. The device of claim 1, wherein the device comprises at least two pressure sensors for measuring pressures in the recess at two points having different distance; and
the calculus member calculates the coefficient C and a square of a rotational speed (ω²) according to measured pressures of at least the two points.

5. The device of claim 4, wherein a detection position of the pressure sensor is disposed at a rotational shaft of the fan blades, and a pressure detected by the pressure sensor is Pi(0).

6. The device of claim 4, wherein
an inner side surface of the cup member is a cylindrical surface, and a diameter of the cylindrical surface is R₁;
an outer side surface of the cup member is a cylindrical surface, and a diameter of the cylindrical surface is R₂; and
the pressure calculated by the calculus member further comprise Po(r)=Pi(R₁)/ln(R₁/R₂)·ln(r/R₂).
